(19) United States
(12) Patent Application Publication
(10) Pub. No.: US 2023/0118562 A1
(43) Pub. Date: Apr. 20, 2023

(54) ZIRCONIUM PHOSPHATE

(71) Applicant: DAIICHI KIGENSO KAGAKU KOGYO CO., LTD., Osaka (JP)

(72) Inventor: Ken KANAZASHI, Osaka-shi (JP)

(73) Assignee: DAIICHI KIGENSO KAGAKU KOGYO CO., LTD., Osaka (JP)

(21) Appl. No.: 17/937,496

(22) Filed: Oct. 3, 2022

(30) Foreign Application Priority Data
Oct. 14, 2021 (JP) 2021-168727

(51) Int. Cl. C01B 25/37; C01B 25/45

(52) U.S. Cl. CPC C01B 25/37; C01B 25/45; C07B 2200/13

(57) ABSTRACT

To provide an unprecedented novel zirconium phosphate. A zirconium phosphate represented by Formula [1]: Zr(Hₐ(NH₄)_{b}(PO₄))(HPO₄).nH₂O, wherein Ia/Ib is 1.0 or less where the maximum peak intensity in the range of 2θ=5 to 13° measured by the X-ray diffraction method is denoted by Ia and the maximum peak intensity in the range of 2θ=26 to 28° is denoted by Ib, and in Formula [1], a, b, and c are numbers satisfying a+b=1 and 0≤b<1, and n is a number satisfying 0≤n≤2.

### BACKGROUND OF THE INVENTION

### Field of the Invention

The present invention relates to a zirconium phosphate.

### Description of the Related Art

Crystalline zirconium phosphate is known as an inorganic ion exchanger that is superior in heat resistance, chemical resistance, oxidation resistance, radiation resistance, and the like and that exhibits specific selectivity for cations and is large in exchange capacity. In particular, a crystalline zirconium phosphate having a layered structure (hereinafter, also referred to as a layered zirconium phosphate) is regarded as promising for use in intercalation, application as a catalyst, and the like as an adsorption-type and ion-exchange-type layered material having various interlayer distances, and has been researched and developed in various fields.

Conventionally, α-type α-Zr(HPO₄)₂ (hereinafter, also referred to as α-zirconium phosphate) and γ-type γ-Zr(HPO₄)₂ (hereinafter, also referred to as γ-zirconium phosphate) are known as layered zirconium phosphate (see, for example, Patent Document 1 and Patent Document 2).

### PRIOR ART DOCUMENT

### Patent Documents

Patent Document 1: JP-A-60-103008

Patent Document 2: JP-A-2012-224518

### SUMMARY OF THE INVENTION

As described above, since a layered zirconium phosphate is superior in various characteristics, it is desired to develop a novel zirconium phosphate having new characteristics.

The present invention has been devised in view of the above-described problems, and an object of the present invention is to provide a novel zirconium phosphate that can have unprecedented new characteristics.

The present inventors have diligently studied zirconium phosphate. As a result, the present inventors have succeeded in creating an unprecedented novel zirconium phosphate having the following configuration, and have accomplished the present invention.

That is, the zirconium phosphate according to the present invention has the following configuration.

A zirconium phosphate represented by Formula [1] below, wherein Ia/Ib is 1.0 or less where the maximum peak intensity in the range of 2θ=5 to 13° measured by the X-ray diffraction method is denoted by Ia and the maximum peak intensity in the range of 2θ=26 to 28° is denoted by Ib,

Zr(Hₐ(NH₄)_{b}(PO₄))(HPO₄).nH₂O [1]

in Formula [1], a and b are numbers satisfying a+b=1 and 0≤b<1, and n is a number satisfying 0≤n≤2.

The Ib is the maximum intensity of a peak corresponding to the array regularity in the plane direction of a layered zirconium phosphate. The Ia is the maximum intensity of a peak corresponding to the interlayer distance in the stacking direction of a layered zirconium phosphate. According to the above configuration, since Ia/Ib is 1.0 or less, the regularity is high with respect to the array regularity in the plane direction, and the regularity is low in interlayer distance in the stacking direction. That is, since Ia/Ib is 1.0 or less, the interlayer distance is weak in orientation (uniformity in interlayer distance).

The zirconium phosphate represented by the Formula [1] and having a configuration in which Ia/Ib is 1.0 or less is a novel zirconium phosphate that is conventionally unknown. The zirconium phosphate has unprecedented new characteristics depending on the content of H (hydrogen) in Formula [1]. That is, the zirconium phosphate can have unprecedented new characteristics according to the value of a or b.

(2) In the configuration of (1), it is preferable that the amount of Li adsorption by the following Li adsorption test is 20% or more, and the amount of Ag adsorption by the following Ag adsorption test is 40% or more.

### <Li Adsorption Test>

(1) After 0.01 mol of LiCl is weighed out, pure water is added to prepare a LiCl solution having a total amount of 20 g. 3 g of zirconium phosphate is charged in the form of a powder to this solution, the mixture is stirred at 25° C. for 120 minutes, and then the zirconium phosphate is centrifugally filtered.
(2) The Li concentration (mol/L) of the filtrate after the above (1) is determined by atomic absorption spectrometry to determine the amount (mol) of Li contained in the filtrate.
(3) The amount (%) of Li adsorption is determined by Equation (a) below.

[amount(%) of Li adsorption]=(1−[amount (mol) of Li in filtrate]/0.01)×100 Equation (a):

### <Ag Adsorption Test>

(4) After 0.01 mol of AgNO₃ is weighed out, pure water is added to prepare an AgNO₃ solution having a total amount of 20 g. 3 g of zirconium phosphate is charged in the form of a powder to this solution, the mixture is stirred at 25° C. for 120 minutes, and then the zirconium phosphate is centrifugally filtered.
(5) The Ag concentration (mol/L) of the filtrate after the above (4) is determined by atomic absorption spectrometry to determine the amount (mol) of Ag contained in the filtrate.
(6) The amount (%) of Ag adsorption is determined by Equation (b) below.

[amount(%) of Ag adsorption]=(1−[amount (mol) of Ag in filtrate]/0.01)×100 Equation (b):

That the amount Li adsorption is 20% or more means that there is a portion where the interlayer distance is a distance corresponding to the radius of Li ions.

In addition, that the amount of Ag adsorption is 40% or more means that there is a portion where the interlayer distance is a distance corresponding to the radius of Ag ions.

Here, Li ions have a relatively small ionic radius. On the other hand, Ag ions have a relatively large ionic radius.

When the amount of Li adsorption is 20% or more and the amount of Ag adsorption is 40% or more, the zirconium phosphate has a portion where the interlayer distance is a distance corresponding to the radius of Li ions and a portion where the interlayer distance is a distance corresponding to the radius of Ag ions. As described above, the zirconium phosphate not being constant in interlayer distance and having various values (distances) is a conventionally unknown, novel zirconium phosphate capable of adsorbing a wide variety of elements including an element having a small ionic radius (for example, Li) and an element having a large ionic radius (for example, Ag).

(3) In the configuration (1) or (2), it is preferable that when exposed to NH₃ gas for 15 minutes under the conditions of 40° C. and 1 atm, the Ia has been increased as compared with that before the exposure.

That the Ia is increased means that the regularity of the interlayer distance in the stacking direction is increased. Here, that the Ia is increased by exposure to NH₃ gas means that NH₃ is adsorbed between layers and the interlayer distance is stabilized at the radius of the NH₃ molecule (the radius of NH₄⁺).

Zirconium phosphate that exhibits such a behavior that exposure to NH₃ gas for 15 minutes increases the Ia is conventionally unknown. That is, the aforementioned zirconium phosphate is a zirconium phosphate having a conventionally unknown, novel structure (crystal structure).

According to the present invention, it is possible to provide a novel zirconium phosphate capable of having unprecedented new characteristics.

### BRIEF DESCRIPTION OF THE DRAWINGS

FIG. 1 shows X-ray diffraction spectra of the zirconium phosphates of Examples 1 and 5 and Comparative Examples 1 and 3;

FIG. 2 is a spectrum obtained by temperature-programmed desorption of ammonia (NH₃-TPD) of the zirconium phosphate of Example 1;

FIG. 3 is a spectrum obtained by temperature-programmed desorption of ammonia (NH₃-TPD) of the zirconium phosphate of Example 5;

FIG. 4 is a spectrum obtained by temperature-programmed desorption of ammonia (NH₃-TPD) of the zirconium phosphate of Comparative Example 1;

FIG. 5 is a spectrum obtained by temperature-programmed desorption of ammonia (NH₃-TPD) of the zirconium phosphate of Comparative Example 2;

FIG. 6 is a spectrum obtained by temperature-programmed desorption of ammonia (NH₃-TPD) of the zirconium phosphate of Comparative Example 3;

FIG. 7 shows X-ray diffraction spectra of the zirconium phosphate of Example 1 before and after exposure to NH₃ gas; and

FIG. 8 shows X-ray diffraction spectra of the precursor compound of Example 1, the precursor compound after heat treatment, the zirconium phosphate of Comparative Example 1, and the zirconium phosphate of Comparative Example 3.

### DETAILED DESCRIPTION OF THE PREFERRED EMBODIMENTS

Hereinafter, embodiments of the present invention will be described. However, the present invention is not limited only to these embodiments. In the present specification, zirconium constituting a zirconium phosphate contains inevitable impurities containing hafnium as a part thereof. In the present specification, a zirconium phosphate may contain impurities other than hafnium such as silica and titania in an amount of 1% by mass or less for manufacturing reasons or the like.

### [Zirconium Phosphate]

A zirconium phosphate according to the present embodiment is represented by Formula [1] below:

Zr(Hₐ(NH₄)_{b}(PO₄))(HPO₄).nH₂O [1]

In Formula [1], a and b are numbers satisfying a+b=1 and 0≤b<1.

b is not particularly limited as long as it is not less than 0 and less than 1. From the viewpoint of the orientation of crystal structure, b is preferably as larger, and is, for example, preferably 0.01 or more, and more preferably 0.1 or more. In addition, from the viewpoint of ion-exchange capacity, b is preferably as smaller, and is, for example, preferably 0.7 or less, and more preferably 0.5 or less.

When the zirconium phosphate has been used as an adsorbent to contain Li, Na, K, Cs, Ag, and the like through adsorption or the like, the zirconium phosphate after the adsorbate adsorption is a zirconium phosphate of Formula [1] that has adsorbed Li, Na, K, Cs, Ag, and the like. The zirconium phosphate after the adsorbate adsorption is a zirconium phosphate of Formula [1] that has adsorbed Li, Na, K, Cs, Ag, and the like, this has a part represented by Formula [1]. Since the zirconium phosphate after the adsorbate adsorption has a part represented by Formula [1], the zirconium phosphate after adsorbate adsorption is also included in the present invention.

Since the zirconium phosphate after the adsorbate adsorption is one obtained by adsorbing Li, Na, K, Cs, Ag, and the like on a zirconium phosphate of Formula [1], the entire zirconium phosphate after the adsorbent adsorption can be represented by Formula [2].

Zr(Hₐ(NH₄)_{b}M_{c}(PO₄))(HPO₄).nH₂O [2]

In Formula [2], M is one or more metals selected from the group consisting of Li, Na, K, Cs, and Ag, a, b, and c are numbers satisfying a+b+c=1, 0≤b<1, and 0≤c<1, and n is a number satisfying 0≤n<2. c is not particularly limited as long as it is not less than 0 and less than 1.

In Formula [1] or [2], n is a number satisfying 0<n≤2. n is not particularly limited as long as it is not less than 0 and not more than 2. n is preferably 0.05 or more, and more preferably 0.1 or more. n is, for example, preferably 1.95 or less, and more preferably 1.8 or less. The smaller n is, the less water is present in the composition. For example, n is preferably as small from the viewpoint of suppressing water from serving as a factor of inhibiting various reactions and the like when dispersed in an organic solvent. From the viewpoint of affinity with water, n is preferably as large.

In the zirconium phosphate according to the present embodiment, Ia/Ib is 1.0 or less where the maximum peak intensity in the range of 2θ=5 to 13° measured by the X-ray diffraction method is denoted by Ia and the maximum peak intensity in the range of 2θ=26 to 28° is denoted by Ib. The Ib is the maximum intensity of a peak corresponding to the array regularity in the plane direction of a layered zirconium phosphate. The Ia is the maximum intensity of a peak corresponding to the interlayer distance in the stacking direction of a layered zirconium phosphate. Since Ia/Ib is 1.0 or less, the regularity is high with respect to the array regularity in the plane direction, and the regularity is low in interlayer distance in the stacking direction. That is, since Ia/Ib is 1.0 or less, the interlayer distance is weak in orientation (uniformity in interlayer distance), and has a flexible interlayer spacing that changes to various values (distances). Since the interlayer distance has flexibility, ions having various ionic radii such as ions having a small ionic radius and ions having a large ionic radius may be present between the layers.

Ia/Ib is not particularly limited as long as it is 1.0 or less, and is, for example, 0.99 or less or 0.8 or less. In addition, Ia/Ib is not particularly limited as long as it is 1.0 or less, and is, for example, 0.01 or more or 0.1 or more. The smaller Ia/Ib is, the weaker the orientation of the interlayer distance (the uniformity of the interlayer distance) is.

The Ia/Ib is determined by the method described in Examples.

The zirconium phosphate has unprecedented new characteristics depending on the content of H (hydrogen) and the content of M in the formula [1] or [2]. That is, the zirconium phosphate can have unprecedented new characteristics according to the values of a, b, and c.

The method for controlling Ia/Ib to 1.0 or less is not particularly limited, and examples thereof include a method in which a precursor compound produced in a solution of raw materials charged for producing the zirconium phosphate is aged while maintaining the pH of the solution in the range of more than 2 and not more than 5 and then heat treatment or acid treatment is performed. Details will be described in the section of the method for producing a zirconium phosphate.

The zirconium phosphate preferably has an amount of Li adsorption by the following Li adsorption test of 20% or more, and an amount of Ag adsorption by the following Ag adsorption test of 40% or more.

The amount of Li adsorption is more preferably 21% or more, even more preferably 22% or more, particularly preferably 23% or more, and extraordinarily preferably 23.5% or more. The amount of Li adsorption is preferably 50% or less, more preferably 45% or less, even more preferably 40% or less, and particularly preferably 35% or less.

The amount of Ag adsorption is more preferably 42% or more, even more preferably 44% or more, particularly preferably 46% or more, extraordinarily preferably 48% or more, and especially preferably 50% or more. The amount of Ag adsorption is preferably 80% or less, more preferably 70% or less, even more preferably 65% or less, and particularly preferably 60% or less.

### <Li Adsorption Test>

(1) After 0.01 mol of LiCl is weighed out, pure water is added to prepare a LiCl solution having a total amount of 20 g. 3 g of zirconium phosphate is charged in the form of a powder to this solution, the mixture is stirred at 25° C. for 120 minutes, and then the zirconium phosphate is centrifugally filtered.
(2) The Li concentration (mol/L) of the filtrate after the above (1) is determined by atomic absorption spectrometry to determine the amount (mol) of Li contained in the filtrate.
(3) The amount (%) of Li adsorption is determined by Equation (a) below.

[amount(%) of Li adsorption]=(1−[amount (mol) of Li in filtrate]/0.01)×100 Equation (a):

### <Ag Adsorption Test>

(4) After 0.01 mol of AgNO₃ is weighed out, pure water is added to prepare an AgNO₃ solution having a total amount of 20 g. 3 g of zirconium phosphate is charged in the form of a powder to this solution, the mixture is stirred at 25° C. for 120 minutes, and then the zirconium phosphate is centrifugally filtered.
(5) The Ag concentration (mol/L) of the filtrate after the above (4) is determined by atomic absorption spectrometry to determine the amount (mol) of Ag contained in the filtrate.
(6) The amount (%) of Ag adsorption is determined by Equation (b) below.

[amount(%) of Ag adsorption]=(1−[amount (mol) of Ag in filtrate]/0.01)×100 Equation (b):

In the Li adsorption test and the Ag adsorption test, the reason why the input amount of zirconium phosphate is specified in g (gram) instead of mol is that it is difficult to express an accurate input amount in mol when the composition of the zirconium phosphate to be measured is not clear. Even if the input amount is expressed in g (gram), an approximate number of moles can be determined, and thus there is no problem as a test for determining an adsorption amount.

That the amount Li adsorption is 20% or more means that there is a portion where the interlayer distance is a distance corresponding to the radius of Li ions.

In addition, that the amount of Ag adsorption is 40% or more means that there is a portion where the interlayer distance is a distance corresponding to the radius of Ag ions.

Here, Li ions have a relatively small ionic radius. On the other hand, Ag ions have a relatively large ionic radius.

When the amount of Li adsorption is 20% or more and the amount of Ag adsorption is 40% or more, the zirconium phosphate has a portion where the interlayer distance is a distance corresponding to the radius of Li ions and a portion where the interlayer distance is a distance corresponding to the radius of Ag ions. As described above, the zirconium phosphate not being constant in interlayer distance having a flexible interlayer spacing that changes to various values (distances) is a conventionally unknown, novel zirconium phosphate.

The Li adsorption test was performed using a LiCl reagent (aqueous solution) under a gentle condition of 25° C. That is, this Li adsorption test is a test in which Li is not forcibly adsorbed between layers of zirconium phosphate with a large adsorption force, but Li ions are adsorbed (fixed) between the layers only when the interlayer distance corresponds to the Li ionic radius.

When the interlayer distance is excessively smaller than the Li ionic radius (when the interlayer distance is only about the H ionic radius), Li ions cannot enter between layers and are not adsorbed. In addition, when the interlayer distance is excessively larger than the Li ionic radius, Li ions are not adsorbed (fixed) between layers because there is no large adsorption force even if the Li ions temporarily enter between the layers.

Similarly, the Ag adsorption test was performed using an AgNO₃ reagent (aqueous solution) under a gentle condition of 25° C. That is, this Ag adsorption test is a test in which Ag is not forcibly adsorbed between layers of zirconium phosphate with a large adsorption force, but Ag ions are adsorbed (fixed) between the layers only when the interlayer distance corresponds to the Ag ionic radius. When the interlayer distance is excessively smaller than the Ag ionic radius, Ag ions cannot enter between layers and are not adsorbed. In addition, when the interlayer distance is excessively larger than the Ag ionic radius, Ag ions are not adsorbed (fixed) between layers because there is no large adsorption force even if the Ag ions temporarily enter between the layers.

When the adsorption test is performed under severe conditions such as strong alkaline conditions or high temperature conditions, the correlation between the interlayer distance and the adsorption amount cannot be obtained. This is because ions are forcibly adsorbed between layers by the action of the ionization energy of the alkali or the thermal energy regardless of the interlayer distance. Therefore, the Li adsorption test and the Ag adsorption test for confirming the interlayer distance need to be performed using a weakly acidic, neutral, or weakly alkaline (strong acidic and strongly alkaline are unacceptable) aqueous solution under a gentle condition of 25° C.

It is preferable with the zirconium phosphate that the ratio of the amount of first ammonia desorption taken in the range of from 90° C. to 200° C. in the temperature programmed desorption of ammonia and the amount of second ammonia desorption taken in the range of from 250° C. to 550° C., [amount of second ammonia desorption]/[amount of first ammonia desorption], is 2.5 or more.

The zirconium phosphate that has adsorbed ammonium preferably desorbs almost all (at least 60% by mass or more) of the ammonia by raising the temperature to 550° C.

That the ratio [amount of second ammonia desorption]/[amount of first ammonia desorption] is 2.5 or more means that in the total amount of ammonia desorbed by raising the temperature to 550° C., the amount of ammonia desorbed in the range of from 90° C. to 200° C. is extremely smaller than the amount of ammonia desorbed in the range of from 250° C. to 550° C. That is, the zirconium phosphate has an unprecedented new characteristic that the desorption of adsorbed ammonia that will occur in a low temperature region (from 90° C. to 200° C.) is extremely suppressed.

The ratio [amount of second ammonia desorption]/[amount of first ammonia desorption] is more preferably 2.51 or more, and even more preferably 2.55 or more. The ratio [amount of second ammonia desorption]/[amount of first ammonia desorption] is preferably as large, but practically, the ratio is, for example, 100 or less.

The temperature programmed desorption of ammonia is a method in which a sample is allowed to adsorb ammonia (NH₃) and then the temperature thereof is continuously raised at a constant temperature rising rate and the amount of ammonia desorbed and the desorption temperature are measured. The ratio [amount of second ammonia desorption]/[amount of first ammonia desorption] is determined by the method described in Examples.

It is preferable that when the zirconium phosphate is exposed to NH₃ gas for 15 minutes under the conditions of 40° C. and 1 atm, the Ia has been increased as compared with that before the exposure.

That the Ia is increased means that the regularity of the interlayer distance in the stacking direction is increased. Here, that the Ia is increased by exposure to NH₃ gas means that NH₃ is adsorbed between layers and the interlayer distance is stabilized at the radius of the NH₃ molecule (the radius of NH₄⁺).

Zirconium phosphate that exhibits such a behavior that exposure to NH₃ gas for 15 minutes increases the Ia is conventionally unknown. That is, the aforementioned zirconium phosphate is a zirconium phosphate having a conventionally unknown, novel structure (crystal structure).

The rate of increase in Ia due to the exposure to NH₃ gas is not particularly limited, and is, for example, more than 1 time, preferably not less than 1.1 times, more preferably not less than 1.6 times, even more preferably not less than 2.2 times, particularly preferably not less than 2.5 times, and extraordinarily preferably not less than 3.0 times, the rate before the exposure to NH₃ gas. The increase rate is preferably as large, and is, for example, not more than 20 times, not more than 10 times, not more than 5 times, or not more than 4 times, that before the exposure to NH₃ gas.

### (Particle Diameter D₉₀)

The particle diameter D₉₀ of the zirconium phosphate is preferably 10 μm or less from the viewpoint of providing a zirconium phosphate having a fine particle size. The particle diameter D₉₀ is more preferably 5 μm or less, and even more preferably 2 μm or less. The particle diameter D₉₀ is preferably smaller from the viewpoint of providing a zirconium phosphate having a small particle size, and can be, for example, 0.01 μm or more or 0.05 μm or more or the like.

### (Particle Diameter D₁₀)

The particle diameter D₁₀ of the zirconium phosphate is preferably smaller from the viewpoint of providing a zirconium phosphate having a fine particle size, but is not particularly limited. The particle diameter D₁₀ can be, for example, preferably 2 μm or less, more preferably 1 μm or less, and even more preferably 0.9 μm or less. The particle diameter D₁₀ can be preferably set to, for example, 0.001 μm or more or the like.

### (Particle Diameter D₅₀)

The particle diameter D₅₀ of the zirconium phosphate is preferably smaller from the viewpoint of providing a zirconium phosphate having a fine particle size, but is not particularly limited. The particle diameter D₅₀ can be set to, for example, 5 μm or less, preferably 3 μm or less, and more preferably 2.5 μm or less or the like. The particle diameter D₅₀ can be set to, for example, 0.01 μm or more, and preferably 0.05 μm or more.

The particle diameter D₁₀, the particle diameter D₅₀, and the particle diameter D₉₀ refer to values obtained by the methods described in Examples. The particle diameter D₁₀, the particle diameter D₅₀, and the particle diameter D₉₀ described in the present specification are measured on a volume basis. The particle diameter D₁₀ is a particle diameter corresponding to a cumulative value of 10% from a minimum particle size value measured by a laser diffraction method. The particle diameter D₅₀ is a particle diameter corresponding to a cumulative value of 50% from a minimum particle size value measured by a laser diffraction method. The particle diameter D₉₀ is a particle diameter corresponding to a cumulative value of 90% from a minimum particle size value measured by a laser diffraction method.

The zirconium phosphate according to the present embodiment has been described above.

### [Method for Producing Zirconium Phosphate]

Hereinafter, an example of a method for producing a zirconium phosphate will be described. However, the method for producing the zirconium phosphate according to the present invention is not limited to the following examples.

The method for producing a zirconium phosphate according to the present embodiment includes:

Step A of preparing an aqueous solution containing a zirconium compound, a compound having two or more carboxyl groups, a phosphoric acid compound, and a compound having ammonium;

Step B of heating the aqueous solution to age a precursor compound produced in the aqueous solution while maintaining a pH in the range of more than 2 and not more than 5; and

Step C of subjecting the aged precursor compound to heat treatment or acid treatment.

In the method for producing a zirconium phosphate according to the present embodiment, first, an aqueous solution including a zirconium compound, a compound having two or more carboxyl groups, and a phosphoric acid compound is prepared (Step A).

Examples of the zirconium compound include zirconium halides such as zirconium oxychloride, zirconium hydroxychloride, zirconium tetrachloride and zirconium bromide; zirconium salts of mineral acids such as zirconium sulfate, basic zirconium sulfate, and zirconium nitrate; zirconium salts of organic acids such as zirconyl acetate and zirconyl formate; and zirconium complex salts such as zirconium ammonium carbonate, sodium zirconium sulfate, zirconium ammonium acetate, sodium zirconium oxalate, and zirconium ammonium citrate. Among these compounds, zirconium oxychloride, zirconium sulfate and the like are more preferable from the viewpoint of productivity.

Examples of the compound having two or more carboxyl groups include aliphatic dibasic acids and salts thereof such as oxalic acid, sodium oxalate, sodium hydrogen oxalate, ammonium oxalate, ammonium hydrogen oxalate, lithium oxalate, maleic acid, malonic acid, succinic acid, and salts thereof; and aliphatic oxyacids and salts thereof such as citric acid, ammonium citrate, tartaric acid, and malic acid. Among these, oxalic acid, and a sodium salt and an ammonium salt thereof are more preferable.

Among the zirconium compounds, zirconium compounds of carboxylic acids having two or more carboxyl groups, such as sodium zirconium oxalate and ammonium zirconium citrate, form a complex having excellent stability in a mixed liquid similarly to the compound having two or more carboxyl groups, and therefore even when the zirconium compounds of carboxylic acids are used as the zirconium compound, the carboxyl group is calculated as C₂O₄ in the mixed liquid.

Examples of the phosphoric acid compound include alkali metal salts and ammonium salts of orthophosphoric acids such as phosphoric acid, monosodium phosphate, disodium phosphate, and trisodium phosphate; and alkali metal salts and ammonium salts of condensed phosphoric acids having at least one P—O—P bond, such as metaphosphoric acid and pyrophosphoric acid. Among these, alkali metal salts and ammonium salts of orthophosphoric acids are more preferable.

Examples of the compound having ammonium include ammonium hydroxide (ammonia water) and ammonium hydrogen carbonate (ammonium bicarbonate).

The mixing ratio of the zirconium compound, the compound having two or more carboxyl groups, the phosphoric acid compound, and the compound having ammonium is preferably within the range of 0.75 to 1.2:0.75 to 1.2:1.3 to 2.5:0.5 to 2.4 in terms of molar ratio.

When the mixing ratio of the zirconium compound, the compound having two or more carboxyl groups, the phosphoric acid compound, and the compound having ammonium is within the above numerical range, the number of unreacted components can be further reduced.

The method for mixing the raw materials is not particularly limited. The raw materials may be mixed at the same time, or the raw materials may be mixed in order. When the raw materials are mixed in order, the order is not particularly limited, but from the viewpoint of suppressing generation of an insoluble substance that is not the intended precursor compound, it is preferable to add the zirconium compound, the phosphoric acid compound, and the compound having two or more carboxyl groups in this order to an aqueous solution of the compound containing ammonium.

In Step A, since a compound having ammonium is added, the pH is usually more than 2 and not more than 5. However, when the pH does not fall within the above numerical range, or in order to perform fine adjustment, a pH adjuster may be added in Step A. Examples of the pH adjuster include mineral acids such as hydrochloric acid, sulfuric acid, and nitric acid; and hydroxides of alkali metals such as sodium hydroxide, potassium hydroxide, and sodium carbonate.

Next, the aqueous solution is heated to age the precursor compound produced in the aqueous solution while maintaining the pH in the range of more than 2 and not more than 5 (Step B). The pH is preferably 2.05 or more, and more preferably 2.30 or more. By setting the pH to more than 2, the precursor compound can be suitably produced. As described later, the precursor compound to be produced has a configuration different from that of both α-zirconium phosphate and γ-zirconium phosphate. When the pH is set to 2 or less, α-zirconium phosphate is to be produced.

The pH is preferably 4.50 or less, and more preferably 3.30 or less. By setting the pH to 5 or less, the reaction rate can be controlled. When the pH is set to more than 5, the production reaction does not substantially occur.

The heating temperature in the aging step (Step B) is not particularly limited, but from the viewpoint of the reaction rate, it is preferably 70° C. or higher, and more preferably 80° C. or higher. The upper limit of the heating temperature is not particularly limited, and is, for example, 200° C. or lower, preferably 190° C. or lower, and more preferably 180° C. or lower.

The aging step (Step B) may be performed under normal pressure (around standard atmospheric pressure (101.33 kPa)) or under a pressurized condition. Examples of the pressurized condition in the case of pressurization include 0.1 MPa or more, 0.2 MPa or more, and 0.5 MPa or more. The upper limit of the pressurized condition is not particularly limited, and is, for example, 1.0 MPa or less, preferably 0.9 MPa or less, and more preferably 0.8 MPa or less.

The time for performing the heating step (Step B) can greatly vary depending on the type of raw materials (that is, the reactivity of the raw materials), the blending ratio of the raw materials, the concentration, temperature, and pH of an aqueous solution, and the desired crystallinity of a reaction product, and the like, but for example, the time is 1 hour or more, preferably 3 hours or more, and more preferably 5 hours or more. From the viewpoint of productivity, the time for performing the aging step is preferably 48 hours or less, and more preferably 24 hours or less.

After the aging step, the temperature and the pressure are usually returned to room temperature (around 25° C.) and normal pressure.

Next, if necessary, the resulting precipitate is thoroughly washed with water to remove excess ions, and then dried. A drying condition is not particularly limited, and preferably within the range of 50° C. to 150° C.

Thus, the precursor compound is obtained. The precursor compound has a Zr((NH₄)(PO₄))(HPO₄) structure having ammonia between layers. The precursor compound has been confirmed to be neither α-type nor γ-type. For example, according to an X-ray diffraction spectrum (see FIG. 8), the precursor compound is different from both α-zirconium phosphate and γ-zirconium phosphate.

That is, the zirconium phosphate according to the present embodiment is different from both α-zirconium phosphate and γ-zirconium phosphate even in the state of the precursor compound in the middle of its production.

Next, the aged precursor compound is subjected to heat treatment or acid treatment (Step C). This Step C is a step of exchanging all or part of NH₄ in the precursor compound for H. Specifically, Step C is a step of exchanging all or part of NH₄ existing at ion exchange sites located between layers of the layered precursor compound for H. When all or part of NH₄ existing at ion exchange sites located between layers is exchanged for H, the orientation (the uniformity of interlayer distance) is weakened. This is consistent with the fact that the peak intensity of Ia is large in the precursor compound after Step B and before Step C, whereas the peak intensity of Ia after Step C is small (see FIG. 8).

The heating temperature in the heat treatment is preferably 250° C. or higher, and more preferably 300° C. or higher from the viewpoint of efficiency of exchange for H. The heating temperature is preferably 500° C. or lower, and more preferably 480° C. or lower from the viewpoint of suppressing thermal decomposition.

The heating step may be performed under normal pressure (around standard atmospheric pressure (101.33 kPa)) or under a pressurized condition. Examples of the pressurized condition in the case of pressurization include 1.05 atm or more, 1.10 atm or more, and 1.15 atm or more. The upper limit of the pressurized condition is not particularly limited, and is, for example, 10 atm or less, preferably 5 atm or less, and more preferably 2 atm or less.

The heating time for performing the heat treatment is preferably 1 hour or more, and more preferably 2 hours or more from the viewpoint of sufficiently exchanging NH₄ for H. The heating time is preferably 10 hours or less, and more preferably 8 hours or less from the viewpoint of productivity.

Examples of the acid treatment agent to be used for the acid treatment include a hydrochloric acid aqueous solution, a nitric acid aqueous solution, a sulfuric acid aqueous solution, and perchloric acid.

The concentration of the aqueous solution to be used for the acid treatment is preferably 1% by mass or more, and more preferably 10% by mass or more. When the concentration is 10% by mass or more, NH₄ can be suitably exchanged for H. The concentration of the aqueous solution to be used for the acid treatment is preferably 20% by mass or less, and more preferably 19% by mass or less from the viewpoint of wastewater.

The acid treatment time is preferably 1 hour or more, and more preferably 2 hours or more. When the acid treatment time is 1 hour or more, NH₄ can be suitably exchanged for H. The acid treatment time is preferably 12 hours or less, and more preferably 10 hours or less from the viewpoint of productivity.

The temperature in the acid treatment is preferably 30° C. or higher, and more preferably 40° C. or higher. When the temperature is 30° C. or higher, NH₄ can be suitably exchanged for H. The temperature is preferably 100° C. or lower, and more preferably 70° C. or lower from the viewpoint of safety.

After the acid treatment, if necessary, the resulting precipitate is thoroughly washed with water to remove excess ions, and then dried. A drying condition is not particularly limited, and preferably within the range of 50° C. to 150° C.

The method for producing the zirconium phosphate according to the present embodiment has been described above.

### EXAMPLES

Hereinafter, the present invention will be described in detail with reference to Examples, but the present invention is not limited to the following Examples as long as the gist thereof is not deviated. The zirconium phosphates in Examples and Comparative Examples contain 1.3 to 2.5% by mass of hafnium as an inevitable impurity in terms of oxide with respect to zirconium (calculated by Formula (X) below). The zirconium phosphates in Examples and Comparative Examples may contain silica and titania as impurities in an amount of 0.1% by mass or less other than hafnium for manufacturing reasons or the like.

([Mass of hafnium oxide]/([mass of zirconium oxide]+[mass of hafnium oxide]))×100(%) <Equation (X)>

The maximum value and the minimum value of the content of each component shown in the following Examples should be considered as a preferable minimum value and a preferable maximum value of the present invention regardless of the content of other components.

In addition, the maximum value and the minimum value of the measured values shown in the following Examples should be considered to be the preferred minimum value and maximum value of the present invention regardless of the content (composition) of each component.

### Production of Zirconium Phosphate

### Example 1

### (Step A)

In 300 ml of pure water were dissolved 0.1 mol of zirconium oxychloride (ZrOCl₂) and 0.2 mol of ammonium bicarbonate (NH₄HCO₃). Next, 0.2 mol of monosodium phosphate (NaH₂PO₄) and 0.1 mol of oxalic acid (HOOC—COOH) were added in the form of an aqueous solution. The concentration of the oxalic acid aqueous solution obtained by charging was 5% by mass. The pH of the resulting aqueous solution was measured to be 2.7. The operations so far were performed at room temperature (25° C.) under normal pressure.

### (Step B)

Next, the mixture was stirred at 120° C. and 0.2 MPa for 18 hours while maintaining the pH at 2.7. Thereafter, the temperature was returned to room temperature (25° C.)

Next, the resulting precipitate was thoroughly washed with water to remove excess ions. Thus, a precursor compound was obtained.

### (Step C)

Next, the obtained precursor compound was heat-treated at 400° C. for 3 hours under normal pressure. As described above, a zirconium phosphate according to Example 1 was obtained.

### Example 2

A zirconium phosphate according to Example 2 was obtained in the same manner as in Example 1 except that the addition amount of oxalic acid was changed to 0.2 mol and the addition amount of ammonium bicarbonate was changed to 0.4 mol. The pH of the aqueous solution after Step A and before Step B was 2.7.

### Example 3

A zirconium phosphate according to Example 3 was obtained in the same manner as in Example 1 except that the heat treatment temperature in Step C was changed to 350° C.

### Example 4

A zirconium phosphate according to Example 4 was obtained in the same manner as in Example 1 except that the heat treatment temperature in Step C was changed to 300° C.

### Example 5

A zirconium phosphate of Example 5 was obtained in the same manner as in Example 1 except that instead of performing the heat treatment at 400° C. for 3 hours, stirring was performed in an aqueous solution containing 0.3 mol of 35% hydrochloric acid for 1 hour, then the resulting precipitate was thoroughly washed with water to remove excess ions and dried at 100° C. for 16 hours.

### Comparative Example 1

In 850 ml of pure water were dissolved 0.62 mol of oxalic acid dihydrate and 0.22 mol of zirconium oxychloride octahydrate, and then 0.46 mol of phosphoric acid was added thereto with stirring. The pH of the resulting aqueous solution was measured to be 0.5. This solution was aged at 98° C. for 10 hours while continuing stirring. The resulting precipitate was thoroughly washed with water in order to remove excess ions, and dried at 150° C. for 16 hours, affording a zirconium phosphate of Comparative Example 1. It is noted that Comparative Example 1 is a replication of Example 1 of JP-A-2012-224518.

### Comparative Example 2

A zirconium phosphate according to Comparative Example 2 was obtained in the same manner as in Comparative Example 1 except that the drying temperature was changed to 400° C.

### Comparative Example 3

In 300 ml of pure water were dissolved 0.05 mol of zirconium oxychloride and 0.16 mol of oxalic acid, and then this mixed solution was heated to 65° C. with stirring. Then, 1.23 mol of monoammonium phosphate was added in the form of an aqueous solution. Subsequently, 6 N aqueous ammonia was added until the pH reached 2.0. Then, the mixture was stirred at 96° C. under normal pressure for 24 hours, and then naturally cooled to room temperature. To the solid reaction product and the mother liquor was added 0.1 mol of concentrated hydrochloric acid, and the mixture was stirred at room temperature for 30 minutes. Then, the resulting precipitate was thoroughly washed with water in order to remove excess ions, and dried at 50° C., affording a zirconium phosphate of Comparative Example 3. It is noted that Comparative Example 3 is a replication of Example 2 of JP-A-60-103008.

### [X-Ray Diffraction Spectrum]

X-ray diffraction spectra of the zirconium phosphates of Examples and Comparative Examples were obtained using an X-ray diffractometer (“RINT2500” manufactured by Rigaku Corporation). The measurement conditions were set as follows.

### <Measurement Conditions>

Measuring apparatus: X-ray diffractometer (RINT2500, manufactured by Rigaku Corporation)

Radiation source: CuKα radiation source

Tube voltage: 50 kV

Tube current: 300 mA

Scanning speed: 2θ=5 to 60°: 4°/min

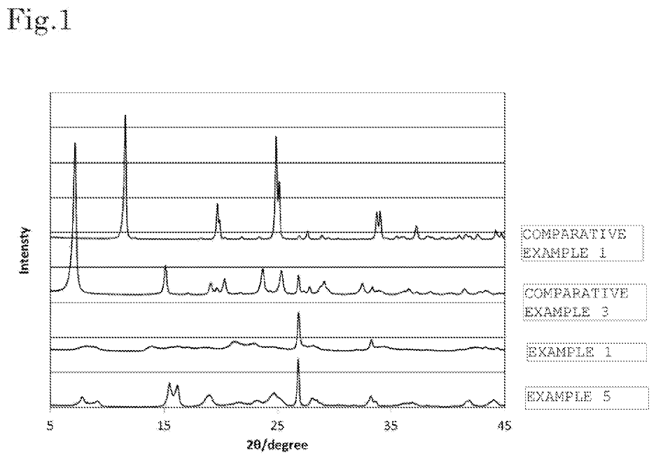

In Table 1 is shown the ratio Ia/Ib of the maximum peak intensity Ia in the range of 2θ=5 to 13° to the maximum peak intensity Ib in the range of 2θ=26 to 28°. For Examples 1 and 5 and Comparative Examples 1 and 3, X-ray diffraction spectra are shown in FIG. 1.

### [Adsorption Test]

### <Li Adsorption Test>

(1) After 0.01 mol of LiCl was weighed out, pure water was added to prepare a LiCl solution having a total amount of 20 g. To this solution was charged 3.0 g of the zirconium phosphate of each of Examples and Comparative Examples in the form of a powder, the mixture was stirred at 25° C. for 120 minutes, and then the zirconium phosphate was centrifugally filtered.
(2) The Li concentration (mol/L) of the filtrate after the above (1) was determined by atomic absorption spectrometry to determine the amount (mol) of Li contained in the filtrate.
(3) The amount (%) of Li adsorption was determined by Equation (a) below.

[amount(%) of Li adsorption]=(1−[amount (mol) of Li in filtrate]/0.01)×100 Equation (a):

The results are shown in Table 1.

### <Ag Adsorption Test>

(4) After 0.01 mol of AgNO₃ was weighed out, pure water was added to prepare an AgNO₃ solution having a total amount of 20 g. To this solution was charged 3.0 g of the zirconium phosphate of each of Examples and Comparative Examples in the form of a powder, the mixture was stirred at 25° C. for 120 minutes, and then the zirconium phosphate was centrifugally filtered.
(5) The Ag concentration (mol/L) of the filtrate after the above (4) was determined by atomic absorption spectrometry to determine the amount (mol) of Ag contained in the filtrate.
(6) The amount (%) of Ag adsorption was determined by Equation (b) below.

[amount(%) of Ag adsorption]=(1−[amount (mol) of Ag in filtrate]/0.01)×100 Equation (b):

The results are shown in Table 1.

The precursor compound of Example 1 was subjected to the same Li adsorption test and Ag adsorption test as those described above. The results are shown as Reference Example 1.

In Examples 1 to 5, the amount of Li adsorption was large, and the amount of Ag adsorption was also large. From this, it was inferred that the zirconium phosphate of each of Examples 1 to 5 is weak in orientation of interlayer distance (the uniformity of interlayer distance) and has a flexible interlayer spacing that changes to various values (distances).

In Comparative Examples 1 and 2, the amount of Li adsorption was small, and the amount of Ag adsorption was also small. This is consistent with the fact that the zirconium phosphate of Comparative Example 1 and the zirconium phosphate of Comparative Example 2 are of α-type, the interlayer distance is narrower than the ionic radius of Li, and the interlayer distance is oriented (uniform).

In Comparative Example 3, the amount of Li adsorption was small, but the amount of Ag adsorption was large. This is consistent with the fact that the zirconium phosphate of Comparative Example 3 is of γ-type, the interlayer distance is large, and the interlayer distance is oriented (uniform). More specifically, that the amount of Ag adsorption is large is consistent with the fact that the interlayer distance is as large as the ionic radius of Ag.

In addition, that the amount of Li adsorption is small is consistent with the fact that there is no (or a little) zirconium phosphate having an interlayer distance close to the Li ionic radius. That is, in the Li adsorption test, when the interlayer distance is excessively larger than the Li ionic radius, Li ions are not adsorbed (fixed) because there is no large adsorption force even if the Li ions temporarily enter between the layers.

[Measurement of Amount of NH₃ Desorption by Temperature Programmed Desorption of Ammonia (NH₃-TPD)]

The amount of NH₃ desorption of a zirconium phosphate was measured by temperature programmed desorption of ammonia using a temperature programmed desorption apparatus (trade name: BELCAT II, manufactured by MicrotracBEL Corp.). Specifically, the measurement was conducted as follows.

First, 0.1 g of precisely weighed zirconium phosphate was placed in a TPD measurement cell, and held for 15 minutes in circulation of NH₃ gas at 30 mL/min and allowed to adsorb NH₃.

Next, the zirconium phosphate after the adsorption of NH₃ was placed in the temperature programmed desorption apparatus, helium was circulated in the apparatus at 50 ml/min, and the temperature was raised to 1000° C. at a temperature raising rate of 10° C./min. As a mass spectrometer for detection, a device having the trade name of BELMass manufactured by MicrotracBEL Corp. was used. The measurement was performed by quantifying ammonia with a fragment of ammonia at m/z=16.

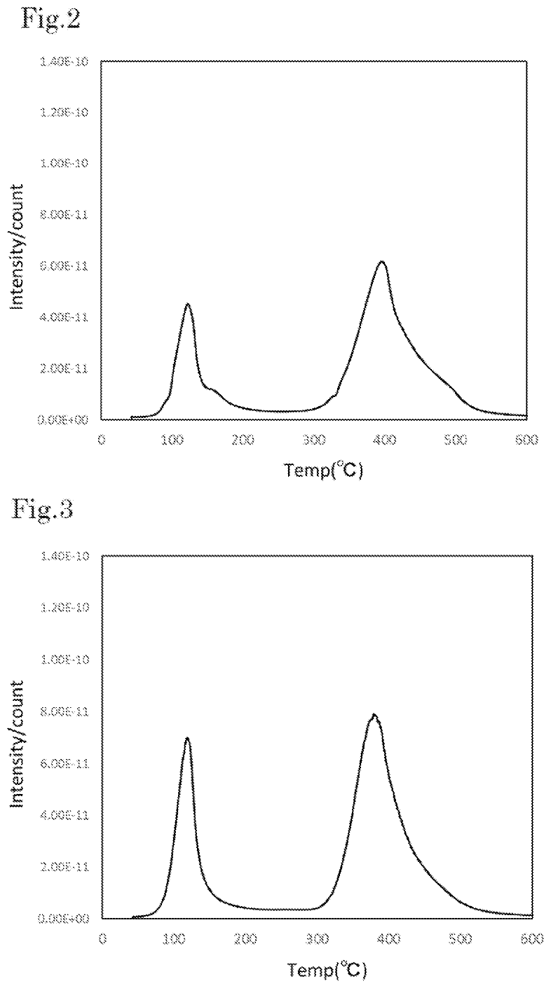

In the resulting mass spectrum, the peak area from 90° C. to 200° C. was defined as the amount of first ammonia desorption, and the peak area from 250° C. to 550° C. was defined as the amount of second ammonia desorption. The ratio [amount of second ammonia desorption]/[amount of first ammonia desorption] is shown in Table 1. In addition, for Examples 1 and 5 and Comparative Examples 1, 2 and 3, the spectra obtained by temperature programmed desorption of ammonia (NH₃-TPD) are shown in FIGS. 2 to 6.

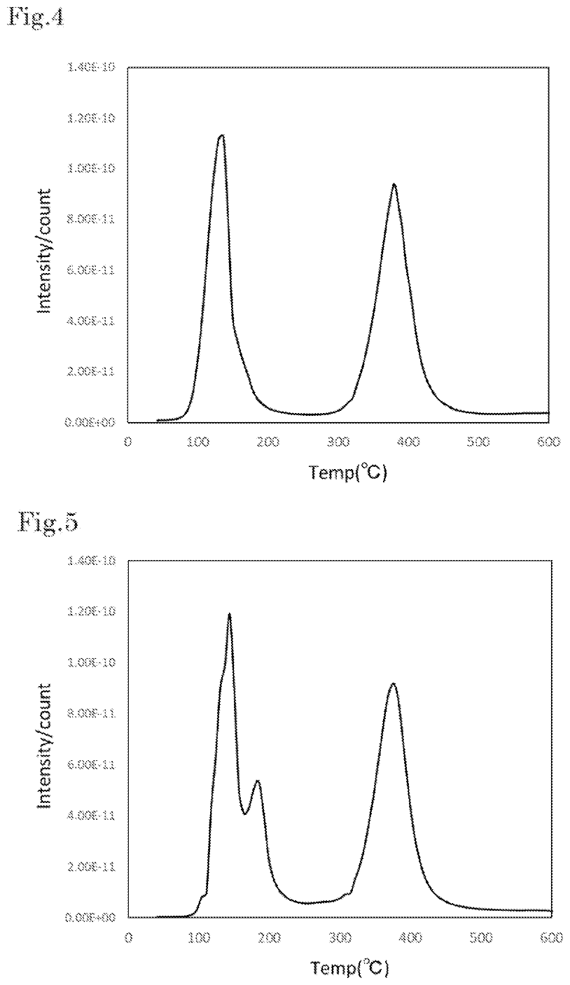

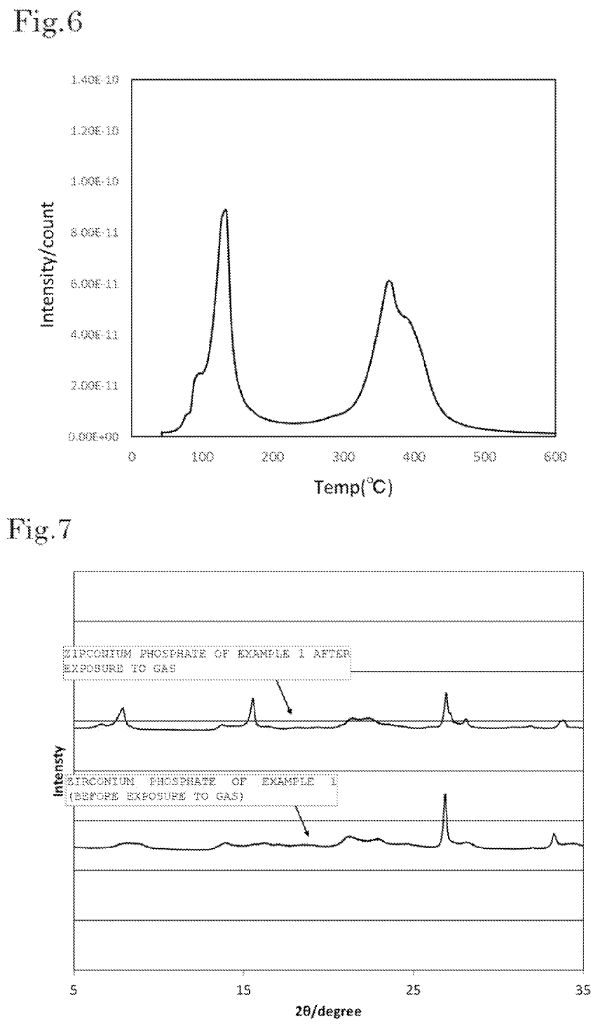

FIG. 2 is a spectrum obtained by temperature-programmed desorption of ammonia (NH₃-TPD) of the zirconium phosphate of Example 1. FIG. 3 is a spectrum obtained by temperature-programmed desorption of ammonia (NH₃-TPD) of the zirconium phosphate of Example 5. FIG. 4 is a spectrum obtained by temperature-programmed desorption of ammonia (NH₃-TPD) of the zirconium phosphate of Comparative Example 1. FIG. 5 is a spectrum obtained by temperature-programmed desorption of ammonia (NH₃-TPD) of the zirconium phosphate of Comparative Example 2. FIG. 6 is a spectrum obtained by temperature-programmed desorption of ammonia (NH₃-TPD) of the zirconium phosphate of Comparative Example 3.

[Measurement of Particle Diameter D₁₀, Particle Diameter D₅₀, and Particle Diameter D₉₀]

Into a 50 ml beaker, 0.15 g of the zirconium phosphate (powder) of each of Examples and Comparative Examples and 40 ml of a 0.2% aqueous sodium hexametaphosphate solution were charged, dispersed with a tabletop ultrasonic cleaner “W-113” (manufactured by Honda Electronics Corporation) for 5 minutes, and then charged into an apparatus (laser diffraction type particle size distribution measuring apparatus (“LA-950” manufactured by Shimadzu Corporation), to measure a particle diameter D₁₀, a particle diameter D₅₀ (median diameter), and a particle diameter D₉₀. The results are shown in Table 1.

### [Analysis of Composition of Zirconium Phosphate]

The composition (in terms of oxide) of the zirconium phosphate prepared in each of Examples and Comparative Examples was analyzed using ICP-AES (“ULTIMA-2” manufactured by HORIBA, Ltd.).

From the X-ray diffraction spectra and the results of composition analysis, the compositions of the zirconium phosphates prepared in Examples and Comparative Examples were found to be as follows.

Example 1: Zr(H_{0.9}(NH₄)_{0.1}(PO₄))(HPO₄).0.5H₂O

Example 2: Zr(H_{0.8}(NH₄)_{0.2}(PO₄))(HPO₄). 0.5H₂O

Example 3: Zr(H_{0.8}(NH₄)_{0.2}(PO₄))(HPO₄).1.0H₂O

Example 4: Zr(H_{0.6}(NH₄)_{0.4}(PO₄))(HPO₄).1.5H₂O

Example 5: Zr(H(PO₄)(HPO₄)).1.5H₂O

Comparative Example 1: α-Zr(PO₄)(H₂PO₄).H₂O

Comparative Example 2: α-Zr(PO₄)(H₂PO₄).0.5H₂O

Comparative Example 3: γ-Zr(PO₄)(H₂PO₄).2H₂O

### [Confirmation of Increase in Ia by Exposure to NH₃ Gas]

The zirconium phosphates of Examples 1 to 5 were exposed to NH₃ gas for 15 minutes under the conditions of 40° C. and 1 atm. Then, X-ray diffraction spectra were obtained. The measurement conditions were the same as those described in the section of “X-ray diffraction spectrum” above.

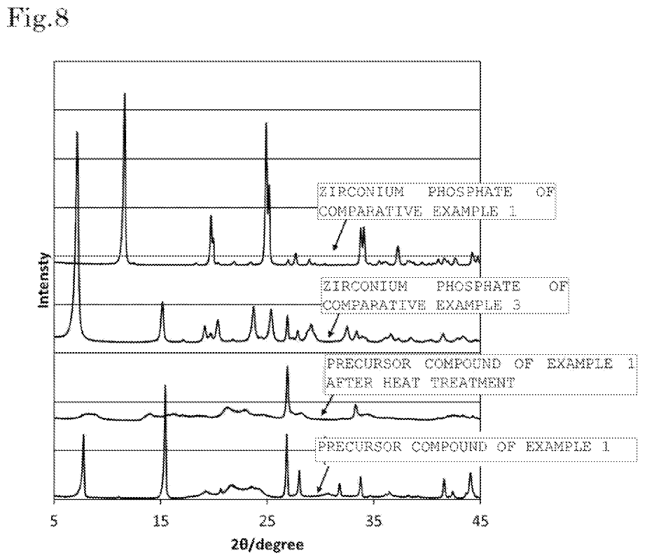

FIG. 7 shows X-ray diffraction spectra of the zirconium phosphate of Example 1 before and after the exposure to NH₃ gas. As is clear from FIG. 7, it was confirmed that the zirconium phosphate after the exposure to NH₃ gas for 15 minutes was increased in the Ia as compared with that before the exposure.

Although not shown, it was confirmed that the zirconium phosphates of Examples 2 to 5 after the exposure to NH₃ gas for 15 minutes were also increased in the Ia as compared with those before the exposure.

On the other hand, the same test was performed for the zirconium phosphates of Comparative Examples 1 to 3, but the Ia after the exposure to NH₃ gas for 15 minutes was decreased as compared with that before the exposure.

TABLE 1

| | | | | | | | Compar- | Compar- | Compar- | Refer- |
|---|---|---|---|---|---|---|---|---|---|---|
| | | Exam- | Exam- | Exam- | Exam- | Exam- | ative | ative | ative | ence |
| | | ple 1 | ple 2 | ple 3 | ple 4 | ple 5 | Example 1 | Example 2 | Example 3 | Example 1 |
| Ia/Ib | | 0.21 | 0.24 | 0.50 | 0.85 | 0.22 | 11 | 11 | 7.7 | — |
| Amount (%) of Li adsorption | | 28.33 | 24.57 | 25.16 | 24.57 | 23.83 | 19.86 | 18.82 | 19.54 | 19.25 |
| Amount (%) of Ag adsorption | | 57.75 | 57.18 | 50.93 | 51.09 | 51.38 | 28.24 | 35.77 | 57.18 | 28.94 |
| Increase rate (times) of Ia by | | 3.0 | 2.2 | 1.6 | 1.1 | 2.5 | 0.57 | 0.50 | 0.94 | — |
| exposure to NH₃ gas | | | | | | | | | | |
| [Amount of second ammonia desorption]/ | | 3.27 | 2.67 | 3.07 | 3.27 | 2.72 | 1.38 | 1.34 | 1.71 | — |
| [Amount of first ammonia desorption] | | | | | | | | | | |
| Particle | Particle diameter D₁₀(μm) | 0.16 | 0.26 | 0.16 | 0.16 | 0.16 | 0.36 | 0.44 | 0.31 | — |
| diameter | Particle diameter D₅₀(μm) | 0.23 | 0.40 | 0.24 | 0.22 | 0.22 | 0.61 | 0.92 | 8.60 | — |
| | Particle diameter D₉₀(μm) | 0.41 | 0.61 | 0.42 | 0.40 | 0.40 | 1.09 | 1.85 | 17.13 | — |

### [Change in X-Ray Diffraction Spectrum Before and After Heat Treatment]

An X-ray diffraction spectrum of the precursor compound produced in the process of producing the zirconium phosphate of Example 1 was obtained. The precursor compound was in a state after aging and before heat treatment. FIG. 8 shows X-ray diffraction spectra of the precursor compound of Example 1, the precursor compound after heat treatment (namely, the zirconium phosphate of Example 1), the zirconium phosphate of Comparative Example 1, and the zirconium phosphate of Comparative Example 3.

From the comparison between the X-ray diffraction spectrum of the precursor compound of Example 1 and the X-ray diffraction spectrum of the precursor compound after the heat treatment, the Ia of the precursor compound was reduced by the heat treatment. From this, it has been confirmed that all or part of NH₄ present at ion exchange sites between layers of a layered precursor compound are replaced with H by heat treatment and the orientation (the uniformity of interlayer distance) is weakened.

Although not shown, the same behavior was observed also in Examples 2 to 5.

What is claimed is:

1. A zirconium phosphate represented by Formula [1] below, wherein Ia/Ib is 1.0 or less where a maximum peak intensity in a range of 2θ=5 to 13° measured by an X-ray diffraction method is denoted by Ia and a maximum peak intensity in a range of 2θ=26 to 28° is denoted by Ib,
Zr(Hₐ(NH₄)_{b}(PO₄))(HPO₄).nH₂O [1]
in Formula [1], a and b are numbers satisfying a+b=1 and 0≤b<1, and n is a number satisfying 0≤n≤2.

2. The zirconium phosphate according to claim 1, wherein
an amount of Li adsorption by a Li adsorption test below is 20% or more, and
an amount of Ag adsorption by an Ag adsorption test below is 40% or more;
in the Li adsorption test,
(1) after 0.01 mol of LiCl is weighed out, pure water is added to prepare a LiCl solution having a total amount of 20 g; 3 g of zirconium phosphate is charged in a form of a powder to this solution, the mixture is stirred at 25° C. for 120 minutes, and then the zirconium phosphate is centrifugally filtered;
(2) a Li concentration (mol/L) of a filtrate after the above (1) is determined by atomic absorption spectrometry to determine an amount (mol) of Li contained in the filtrate; and
(3) an amount (%) of Li adsorption is determined by Equation (a) below,
[amount(%) of Li adsorption]=(1−[amount (mol) of Li in filtrate]/0.01)×100; and Equation (a):
in the Ag adsorption test,
(4) after 0.01 mol of AgNO₃ is weighed out, pure water is added to prepare an AgNO₃ solution having a total amount of 20 g; 3 g of zirconium phosphate is charged in a form of a powder to this solution, the mixture is stirred at 25° C. for 120 minutes, and then the zirconium phosphate is centrifugally filtered;
(5) an Ag concentration (mol/L) of a filtrate after the above (4) is determined by atomic absorption spectrometry to determine an amount (mol) of Ag contained in the filtrate; and
(6) an amount (%) of Ag adsorption is determined by Equation (b) below,
[amount(%) of Ag adsorption]=(1−[amount (mol) of Ag in filtrate]/0.01)×100. Equation (b):

3. The zirconium phosphate according to claim 1, wherein when the zirconium phosphate is exposed to NH₃ gas for 15 minutes under conditions of 40° C. and 1 atm, the Ia is increased as compared with that before the exposure.
